(19) United States
(12) Patent Application Publication
(10) Pub. No.: US 2021/0284031 A1
(43) Pub. Date: Sep. 16, 2021

(54) POWER CONTROL UNIT

(71) Applicants: TOYOTA JIDOSHA KABUSHIKI KAISHA, Aichi-ken (JP); SUBARU CORPORATION, Tokyo (JP)

(72) Inventor: Hiroyuki YAMADA, Toyota-shi (JP)

(21) Appl. No.: 17/177,201

(22) Filed: Feb. 17, 2021

(30) Foreign Application Priority Data
Mar. 13, 2020 (JP) 2020-044102

(51) Int. Cl. B60L 50/64; B60K 1/04; B60L 53/18

(52) U.S. Cl. CPC B60L 50/64; B60K 2001/0411; B60L 53/18; B60K 1/04

(57) ABSTRACT

A power control unit mounted in a front space of a vehicle and configured to control power input to a power storage device mounted on the vehicle and power output from the power storage device, includes: a housing; and a plurality of electronic components provided in the housing. Further, the plurality of electronic components includes a class-1 component defined as a target required to suppress exposure from the housing and a class-2 component other than the class-1 component, a protrusion is provided on a part of a side surface of the housing so as to protrude beyond the other parts of the side surface, and the class-2 component is disposed adjacent to the protrusion.

### CROSS-REFERENCE TO RELATED APPLICATION(S)

The present application claims priority to and incorporates by reference the entire contents of Japanese Patent Application No. 2020-044102 filed in Japan on Mar. 13, 2020.

### BACKGROUND

The present disclosure relates to a power control unit.

In an electric vehicle disclosed in Japanese Laid-open Patent Publication No. 2018-024382, a traveling motor and a power control unit that controls the power supplied to the traveling motor are disposed in a front compartment which is a front space provided in front of a cabin.

In the power control unit of an electric vehicle disclosed in Japanese Laid-open Patent Publication No. 2018-024382, an electronic component carrying high voltage during traveling is provided in a metal housing. Unfortunately, the power control unit of the electric vehicle disclosed in Japanese Laid-open Patent Publication No. 2018-024382 has a problem that when the electric vehicle has a frontal collision while traveling, the housing of an electronic control unit would be damaged to expose electronic components carrying high voltage to the outside.

### SUMMARY

There is a need for providing a power control unit capable of suppressing exposure of an electronic component defined as a target required to suppress exposure from a housing, to the outside from the housing, when a vehicle has a frontal collision.

According to an embodiment, a power control unit mounted in a front space of a vehicle and configured to control power input to a power storage device mounted on the vehicle and power output from the power storage device, includes: a housing; and a plurality of electronic components provided in the housing. Further, the plurality of electronic components includes a class-1 component defined as a target required to suppress exposure from the housing and a class-2 component other than the class-1 component, a protrusion is provided on a part of a side surface of the housing so as to protrude beyond the other parts of the side surface, and the class-2 component is disposed adjacent to the protrusion.

### BRIEF DESCRIPTION OF THE DRAWINGS

FIG. 1 is a view illustrating a body of an electric vehicle according to an embodiment;

FIG. 2 is a plan view of a compartment;

FIG. 3 is a perspective view of a compartment;

FIG. 4 is a block diagram related to power control of an electric vehicle according to an embodiment;

FIG. 5 is an external perspective view of a Smart Power Unit (SPU);

FIG. 6 is a cross-sectional view of the SPU taken in a vehicle height direction in D-D cross section of FIG. 5;

FIG. 7A is a cross-sectional view of a case upper portion taken in a vehicle front-rear direction of in the E-E cross section of FIG. 5;

FIG. 7B is a cross-sectional view of a case lower portion taken in the vehicle front-rear direction in the C-C cross section of FIG. 5;

FIG. 8 is a view of the SPU as viewed from the rear side in the vehicle front-rear direction;

FIG. 9 is a plan view of a compartment equipped with the SPU;

FIG. 10 is a partially enlarged view of the SPU mounted on a component mounting frame;

FIG. 11A is a view illustrating a right side portion in a vehicle width direction of the SPU according to a configuration example 1 in the D-D cross section of FIG. 9;

FIG. 11B is a view illustrating a left side portion in the vehicle width direction of the SPU according to the configuration example 1 in the E-E cross section of FIG. 9;

FIG. 12A is a view illustrating the right side portion of the SPU according to a configuration example 2 in the D-D cross section of FIG. 9;

FIG. 12B is a view illustrating the left side portion of the SPU according to the configuration example 2 in the E-E cross section of FIG. 9;

FIG. 13A is a view illustrating a right side portion of the SPU according to a configuration example 3;

FIG. 13B is a view illustrating a left side portion of the SPU according to the configuration example 3;

FIG. 14A is a view illustrating a right side portion of the SPU according to a configuration example 4; and

FIG. 14B is a view illustrating a left side portion of the SPU according to the configuration example 4.

### DETAILED DESCRIPTION

Hereinafter, an embodiment of the power control unit according to the present disclosure will be described. Note that the present disclosure is not limited to the present embodiment.

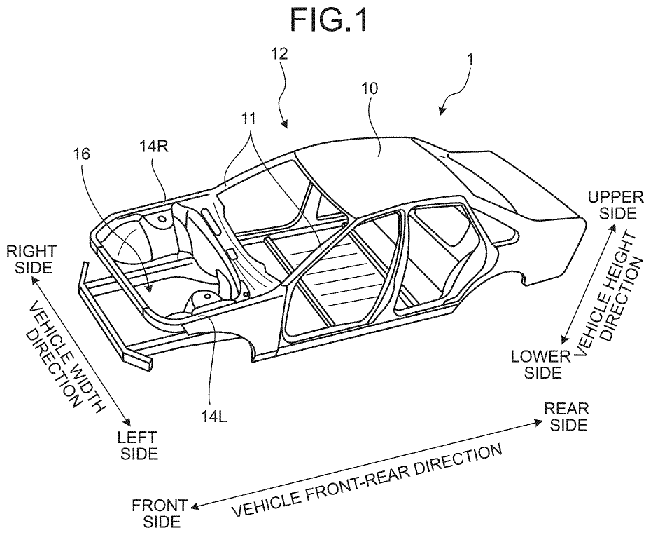

FIG. 1 is a view illustrating a body 10 of an electric vehicle 1 according to an embodiment. The body 10 includes a front pillar 11 and apron upper members 14 extending forward from the front pillar 11 (that is, a right apron upper member 14R and a left apron upper member 14L). The body 10 includes a compartment 16 which is a vehicle front section in a range surrounded by the two apron upper members 14. The compartment 16 is provided in front of a cabin 12.

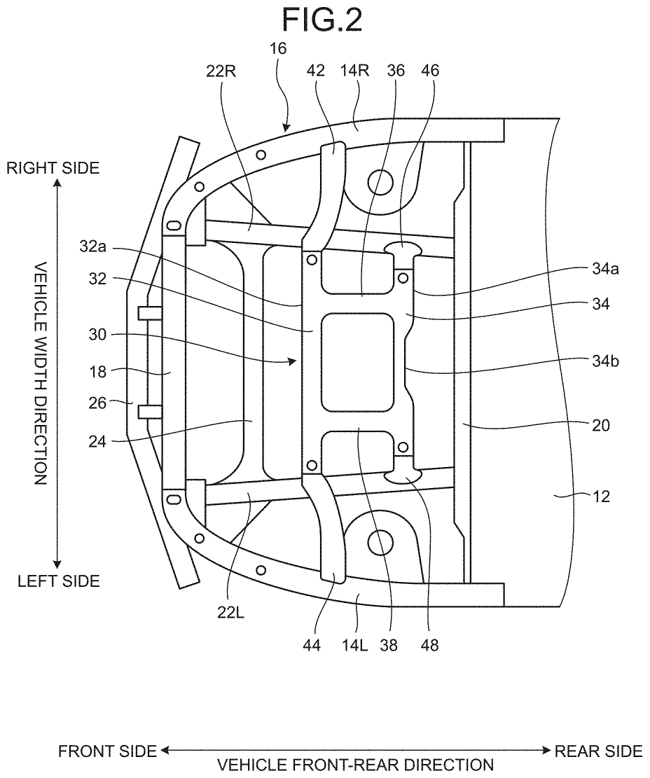

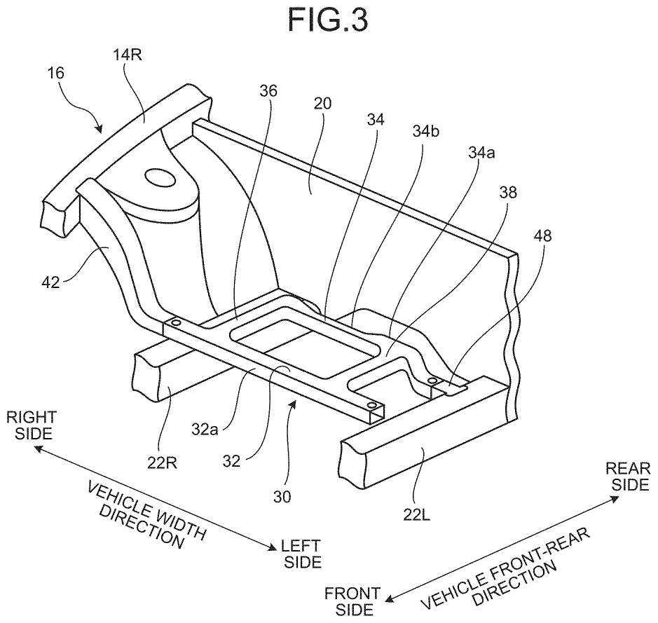

FIG. 2 is a plan view of the compartment 16. FIG. 3 is a perspective view of the compartment 16. At the rear of compartment 16, a dash panel 20 is disposed. The dash panel 20 separates the compartment 16 from the cabin 12. The right apron upper member 14R and the left apron upper member 14L respectively extend along left and right edges of the compartment 16. The right apron upper member 14R and the left apron upper member 14L are connected to each other by a core support 18 at the forefront part of the body 10. The core support 18 constitutes a front edge of the compartment 16.

Inside the compartment 16, a pair of front side members 22 (right front side member 22R and left front side member 22L) are provided. Each of the front side members 22 extends in the front-rear direction. The front side members 22 are disposed below the apron upper member 14.

The right front side member 22R and the left front side member 22L are connected to each other by a front cross member 24 in the compartment 16. The right front side member 22R and the left front side member 22L are connected to a bumper reinforcement 26 at the forefront part of the body 10.

Inside the compartment 16, a component mounting frame 30 is disposed. The component mounting frame 30 is fixed to the body 10 in the compartment 16. The component mounting frame 30 includes a front cross member 32, a rear cross member 34, a right connecting member 36, and a left connecting member 38.

The front cross member 32 extends long in the left-right direction. The right end of the front cross member 32 is connected to a bracket 42. The bracket 42 extends diagonally upward and is connected to the right apron upper member 14R. That is, the right end of the front cross member 32 is connected to the right apron upper member 14R via the bracket 42. The left end of the front cross member 32 is connected to a bracket 44. The bracket 44 extends diagonally upward and is connected to the left apron upper member 14L. That is, the left end of the front cross member 32 is connected to the left apron upper member 14L via the bracket 44.

The rear cross member 34 extends long in the left-right direction. The rear cross member 34 is disposed behind the front cross member 32. On a rear side surface 34a (side surface facing the dash panel 20) of the rear cross member 34, a recess 34b is formed. The right end of the rear cross member 34 is connected to the right front side member 22R via a bracket 46. The left end of the rear cross member 34 is connected to the left front side member 22L via a bracket 48.

The right connecting member 36 extends long in the front-rear direction. The right connecting member 36 connects the front cross member 32 and the rear cross member 34. The left connecting member 38 extends long in the front-rear direction. The left connecting member 38 connects the front cross member 32 and the rear cross member 34.

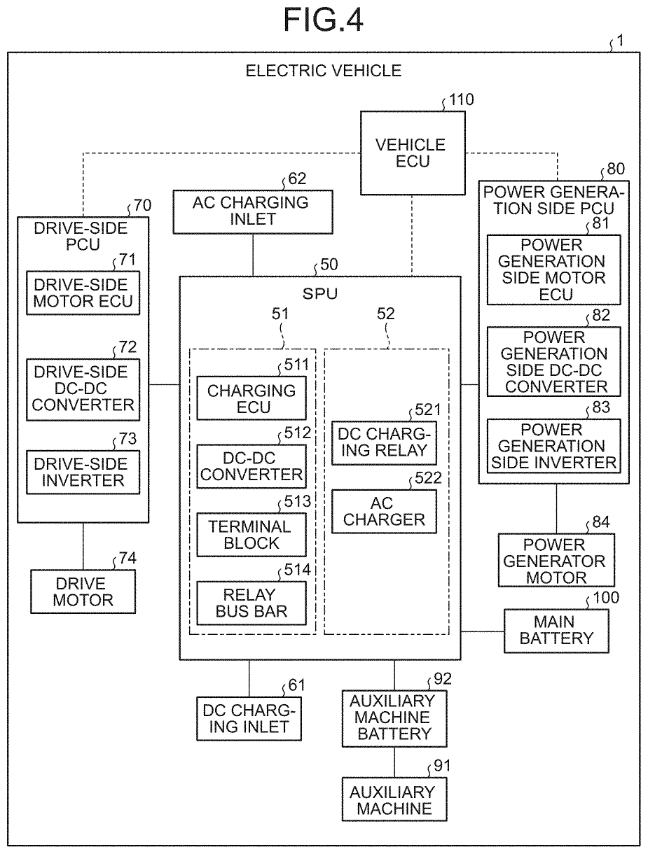

FIG. 4 is a block diagram related to power control of the electric vehicle 1 according to an embodiment. As illustrated in FIG. 4, the electric vehicle 1 includes a Smart Power Unit (SPU) 50, a Direct Current (DC) charging inlet 61, an alternating current (AC) charging inlet 62, a drive-side Power Control Unit (PCU) 70, a drive motor 74, a power generation side PCU 80, a power generator motor 84, an auxiliary machine 91, an auxiliary machine battery 92, a main battery 100, and a vehicle Electronic Control Unit (ECU) 110.

The power control unit SPU 50 of the present disclosure includes a plurality of electronic components such as a charging ECU 511, a DC-DC converter 512, a terminal block 513, a relay bus bar 514, a DC charging relay 521, and an AC charger 522.

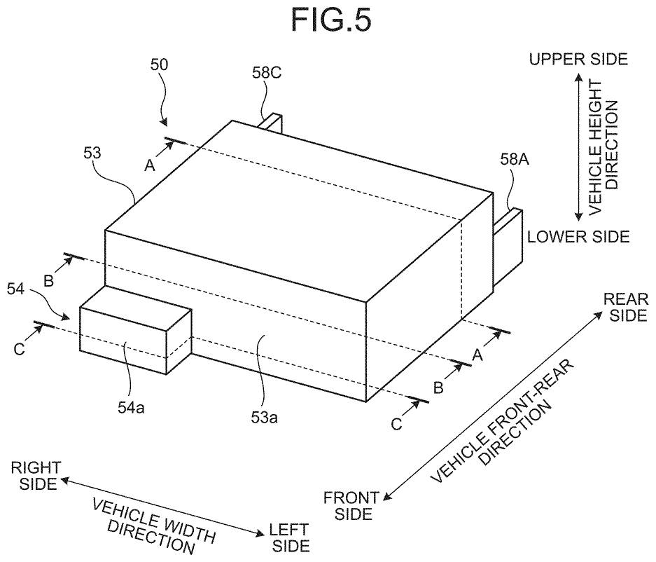

The SPU 50 controls the power input to the main battery 100, which is a power storage device mounted on the electric vehicle 1, and the power output from the main battery 100. That is, the SPU 50 implements power control between the main battery 100 and the drive motor 74, power control for external charging of the main battery 100 via the DC charging inlet 61 and the AC charging inlet 62, and power control between the power generator motor 84 and the main battery 100 or the like. The SPU 50 includes a case 53 (refer to FIG. 5), which is a metal housing, and a plurality of electronic components provided in the case 53.

The plurality of electronic components include: a high voltage component 51, which is a class-1 component defined as a target required to suppress exposure from the case 53, whose operating voltage becomes a high voltage being a predetermined value or more when the electric vehicle 1 is traveling; and a low voltage component 52, which is a class-2 component other than the class-1 component, having a voltage lower than the high voltage component 51 when the electric vehicle 1 is traveling.

From the viewpoint of safety, the high voltage component 51 can be any electronic component that is required to suppress exposure from the case 53 due to damage to the case 53 in the event of a vehicle collision or the like. Such a request may follow the provisions of various rules such as laws, for example. The high voltage component 51 can be an electronic component having an operating voltage of DC 60 V or higher or AC 30 V or higher, for example. Furthermore, the operating voltage of the high voltage component 51 can be DC 100 V or higher. Furthermore, the operating voltage of the high voltage component 51 can be DC 300 V or less.

In the electric vehicle 1 according to the embodiment, examples of the high voltage component 51 include the charging ECU 511, the DC-DC converter 512, the terminal block 513, and the relay bus bar 514, to which power is supplied during traveling of the electric vehicle 1. Examples of the low voltage component 52 include the DC charging relay 521 and the AC charger 522, which are electronic components used for external charging of the main battery 100, to which power is not supplied during the travel of the electric vehicle 1.

The charging ECU 511 controls the DC-DC converter 512, the DC charging relay 521, the AC charger 522 or the like, based on a control signal from the vehicle ECU 110.

The AC charger 522 converts AC power from an external AC power source provided outside the electric vehicle 1 into DC power and supplies the power to the main battery 100 to charge the main battery 100. The DC-DC converter 512 steps down the DC power supplied from the main battery 100 to the auxiliary machine battery 92 for supplying power to the auxiliary machine 91 such as a car navigation system and an air conditioner. The terminal block 513 and the relay bus bar 514 are used as a current path for high-voltage current and a current path for rapid charging by DC power from an external DC power source.

The electric vehicle 1 according to an embodiment is capable of performing DC external charging, that is, charging the main battery 100 by using DC power supplied from a DC external power source via the DC charging inlet 61 when the vehicle is stopped.

The DC charging inlet 61 is connectable to a DC charging connector provided at one end of a DC charging cable having the other end connected to a DC external power source. Normally, that is, when DC external charging for the main battery 100 is not performed, the DC charging inlet 61 is covered with a DC charging lid. When DC external charging for the main battery 100 is performed, the DC charging lid is opened and a DC charging connector is connected to the DC charging inlet 61.

One end of the DC charging relay 521 is electrically connected to the DC charging inlet 61 via a power line. The other end of the DC charging relay 521 is electrically connected to the main battery 100 via a power line. Open/closed states of the DC charging relay 521 are switched in accordance with the control signal from the charging ECU 511. The DC charging relay 521 is switched from an open state to a closed state when DC external charging for the main battery 100 is performed. By switching the DC charging relay 521 to the closed state in this manner, the DC power received from the DC charging connector via the DC charging inlet 61 can be supplied to the main battery 100. With this configuration, the main battery 100 is charged using the DC power supplied from the DC external power source.

Furthermore, the electric vehicle 1 according to an embodiment is capable of performing AC external charging, that is, charging the main battery 100 by using AC power supplied from an AC external power source via the AC charging inlet 62 when the vehicle is stopped.

The AC charging inlet 62 is connectable to an AC charging connector provided at one end of an AC charging cable having the other end connected to an AC external power source. Normally, that is, when AC external charging for the main battery 100 is not performed, the AC charging inlet 62 is covered with an AC charging lid. When performing AC external charging of the main battery 100, the AC charging lid is opened and an AC charging connector is connected to the AC charging inlet 62.

The AC charger 522 is electrically connected to the AC charging inlet 62 and the main battery 100 via a power line. The AC charger 522 operates by a control signal from the charging ECU 511, converts the AC power received from the AC charging connector via the AC charging inlet 62 into DC power that can be charged to the main battery 100, and then supplies the converted DC power to the main battery 100. With this configuration, the main battery 100 is charged using the AC power supplied from the AC external power source.

The drive-side PCU 70 includes a drive-side motor ECU 71, a drive-side DC-DC converter 72, a drive-side inverter 13 or the like. The drive-side DC-DC converter 12 boosts the DC voltage supplied from the main battery 100 via the SPU 50, based on the control signal from the drive-side motor ECU 71. The boosted DC voltage is supplied to the drive-side inverter 73. The drive-side inverter 73 converts the DC power from the drive-side DC-DC converter 72 into AC power based on the control signal from the drive-side motor ECU 71, and then supplies the AC power to the drive motor 74.

The drive motor 74 is rotationally driven by AC power from the PCU 160. The rotational driving force from the drive motor 74 is transmitted to the drive wheels, which are the front wheels of the electric vehicle 1, via a transaxle, an axle or the like, and this transmitted driving force allows the electric vehicle 1 to travel. Furthermore, the drive motor 74 regeneratively generates power by the rotational driving force transmitted from the drive wheels via the axles or the like when the traveling electric vehicle 1 decelerates or the like. The AC power generated by the drive motor 74 is converted into DC power having a predetermined voltage by the drive-side DC-DC converter 72 and the drive-side inverter 73 provided in the drive-side PCU 70, so as to be stored in the main battery 100 via the SPU 50.

The power generation side PCU 80 includes a power generation side motor ECU 81, a power generation side DC-DC converter 82, a power generation side inverter 83 or the like. When the electric vehicle 1 is traveling, the power generator motor 84 regeneratively generates power by a rotational driving force transmitted from the rear wheels of the electric vehicle 1 via an axle or the like. The AC power generated by the power generator motor 84 is converted into DC power of a predetermined voltage by the power generation side DC-DC converter 82 and the power generation side inverter 83 based on the control signal from the drive-side motor ECU 71, and is stored in the main battery 100 via the SPU 50.

The main battery 100 is a rechargeable and dischargeable in-vehicle power storage device that functions as an in-vehicle DC power source. Examples of the applicable main battery 100 include a secondary battery such as a lithium ion secondary battery or a nickel hydrogen battery, or a capacitor such as an electric double layer capacitor.

FIG. 5 is an external perspective view of the SPU 50. As illustrated in FIG. 5, the SPU 50 according to the embodiment has a protrusion 54 provided on a part of a front side surface 53a of the case 53. Specifically, the protrusion 54 is provided on the front side surface 53a of the case 53, protruding to the front side in the vehicle front-rear direction beyond the other parts of the front side surface 53a, specifically provided on the right side in a vehicle width direction and on a lower side in a vehicle height direction. The protrusion 54 is obtained by forming a part of the front side surface 53a of the case 53 to protrude toward the front side in the vehicle front-rear direction beyond the other parts. Accordingly, the front side surface 54a of the protrusion 54 is a part of the front side surface 53a of the case 53. With a configuration in which the protrusion 54 is obtained by forming a part of the front side surface 53a of the case 53 to protrude toward the front side in the vehicle front-rear direction beyond the other parts, it is possible to reduce the number of components compared to the case where the protrusion 54 is provided separately from the case 53, leading to achievement of cost reduction. The case 53 can be integrally molded with the protrusion 54 by die casting, for example.

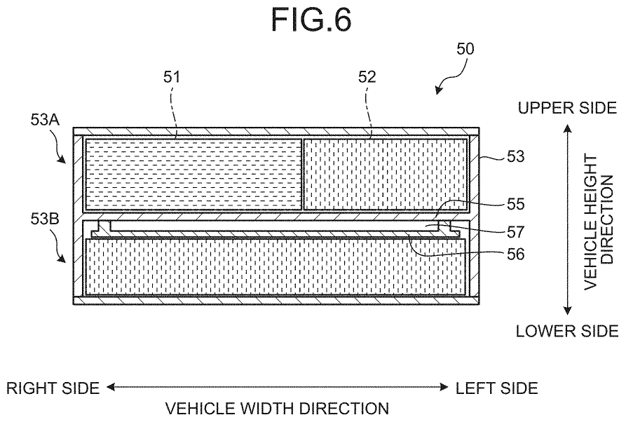

In the present embodiment, although there are connectors and openings for electrically connecting to individual electronic components in the case 53, and nozzles or the like for the inflow/outflow of the coolant for a flow path 57 described below (refer to FIG. 6), being provided on the front, rear, left, and right side surfaces of the case 53 or the like, their illustrations are omitted.

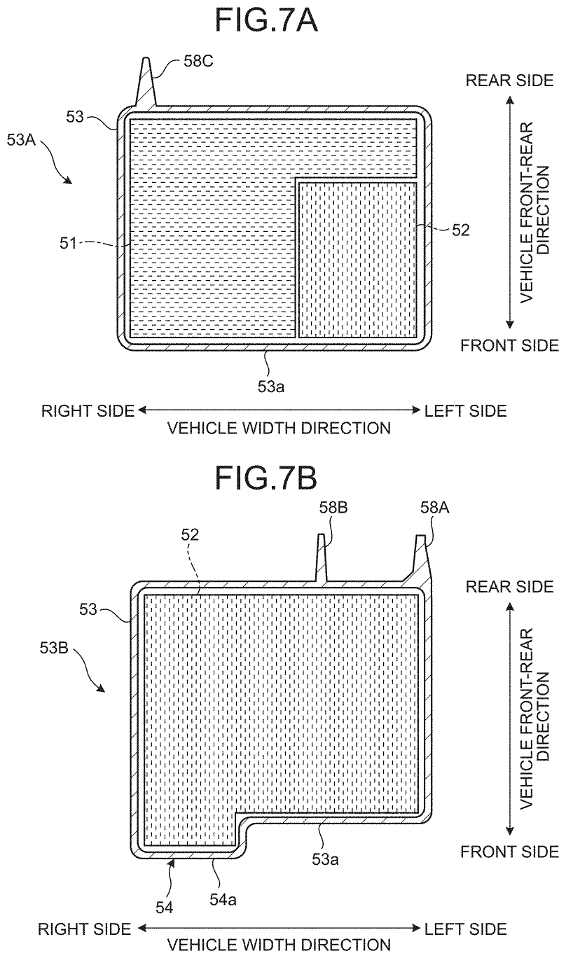

FIG. 6 is a cross-sectional view of the SPU 50 taken in the vehicle height direction in the cross section A-A of FIG. 5. FIG. 7A is a cross-sectional view of a case upper portion 53A taken in vehicle front-rear direction in the B-B cross section of FIG. 5. FIG. 7B is a cross-sectional view of a case lower portion 53B taken in the vehicle front-rear direction in the C-C cross section of FIG. 5.

As illustrated in FIG. 6, the inner part of the case 53 is divided into the case upper portion 53A and the case lower portion 53B by a partition wall 55 having a flat plate-shape. In the case lower portion 53B, a flow path forming member 56 is attached to the lower surface of the partition wall 55, so as to form a flow path 57 to allow the flow of the coolant, in the space surrounded by the partition wall 55 and the flow path forming member 56. As illustrated in FIG. 7A, the high voltage component 51 and the low voltage component 52 are disposed on the case upper portion 53A. Furthermore, as illustrated in FIG. 7B, the low voltage component 52 is disposed in the case lower portion 53B. The low voltage component 52 is adjacent to the protrusion 54 in the vehicle front-rear direction. The high voltage component 51 and the low voltage component 52 disposed in the case upper portion 53A and the low voltage component 52 disposed in the case lower portion 53B are cooled by the coolant flowing through the flow path 57.

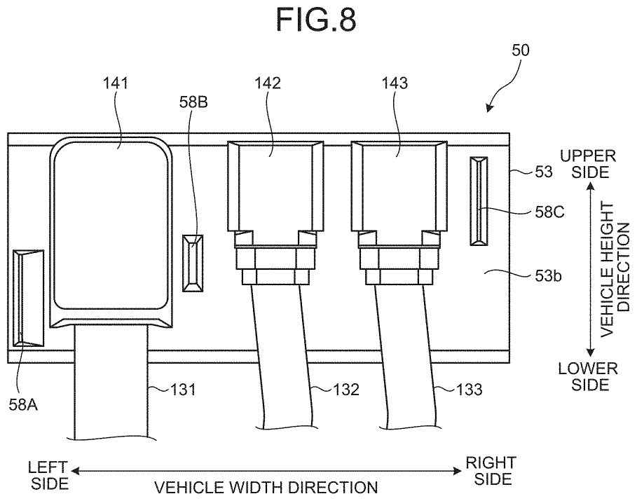

FIG. 8 is a view of the SPU 50 as viewed from the rear side in the vehicle front-rear direction. As illustrated in FIG. 8, three power cables 131, 132, and 133 are disposed on the rear side surface 53b of the case 53. The three power cables 131, 132, and 133 are electrically connected to the three connectors 141, 142, and 143 provided on the rear side surface 53b of the case 53.

The power cable 131 electrically connects the SPU 50 and the main battery 100 via the connector 141. The power cable 132 electrically connects the SPU 50 and the drive-side PCU 70 via a connector 142. The power cable 133 electrically connects the SPU 50 and the power generation side PCU 80 via the connector 143.

Furthermore, as illustrated in FIG. 8, three ribs 58A, 58B, and 58C are provided on the rear side surface 53b of the case 53, respectively adjacent to each of the three power cables 131, 132, and 133. The three ribs 58A, 58B, and 58C are erected from the rear side surface 53b of the case 53 toward the rear side in the vehicle front-rear direction, that is, the dash panel 20 side. The height of each of the three ribs 58A, 58B, and 58C from the rear side surface 53b is respectively higher than the height of each of the three connectors 141, 142, and 143 from the rear side surface 53b.

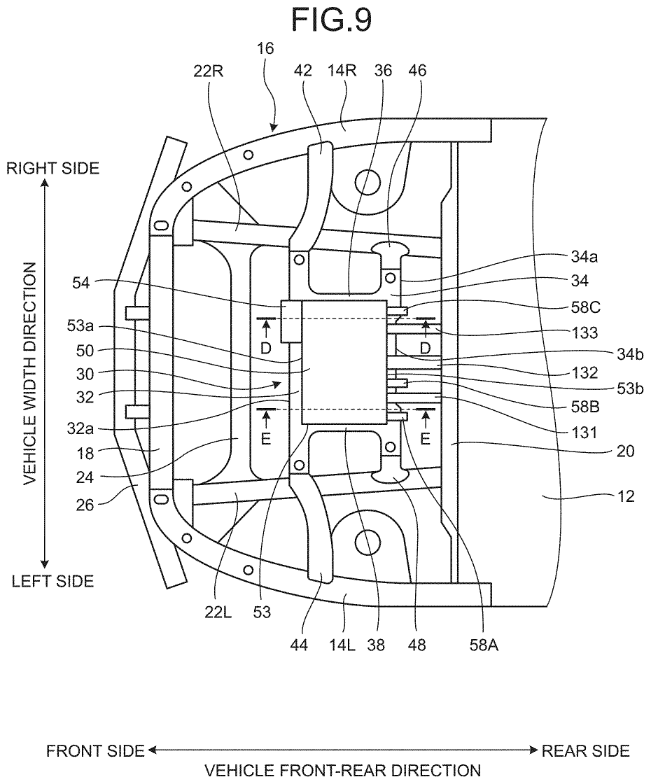

FIG. 9 is a plan view of the compartment 16 equipped with the SPU 50. As illustrated in FIG. 9, in the top view of the compartment 16, the rear side surface 53b of the case 53 of the SPU 50 is located in front of the rear side surface 34a of the rear cross member 34 (the entire rear side surface 34a including the recess 34b). That is, in the top view of the compartment 16, the case 53 does not protrude rearward beyond the rear side surface 34a of the rear cross member 34. Furthermore, as illustrated in FIG. 9, in the top view of the compartment 16, the front side surface 53a of the case 53 is located behind a front side surface 32a of the front cross member 32. That is, in the top view of the compartment 16, the case 53 does not protrude toward the front beyond the front side surface 32a of the front cross member 32. Furthermore, as illustrated in FIG. 9, in the top view of the compartment 16, the protrusion 54 protrudes toward the front beyond the front side surface 32a of the front cross member 32.

When the electric vehicle 1 has a frontal collision, the body 10 is deformed. Due to the deformation of the body 10, the case 53 is pushed out rearward (toward dash panel 20 side) together with the component mounting frame 30. At this time, with the presence of the ribs 58A, 58B, and 58C on the rear side surface 53b of the case 53, the ribs 58A, 58B, and 58C are likely to collide with the dash panel 20 before the rear side surface 53b. With this configuration, the ribs 58A, 58B, and 58C are stretched, making it difficult for the power cables 131, 132, and 133 to be pinched between the rear side surface 53b of the case 53 and the dash panel 20, suppressing the damage to the power cables 131, 132, and 133. Furthermore, the ribs 58A, 58B, and 58C collide with the dash panel 20 before the rear side surface 53b of the case 53, and the ribs 58A, 58B, and 58C receive the collision load. This makes it possible to reduce the collision load input to the rear side surface 53b, so as to suppress damage to the case 53.

Furthermore, when the electric vehicle 1 has a frontal collision, the front body component (the body component (for example, the core support 18 or the like) constituting the front part of the compartment 16) is pushed rearward (case 53 side). This brings the front body component into contact with the case 53 and the component mounting frame 30. At this time, since the case 53 is disposed behind the front side surface 32a of the front cross member 32, the front body component is highly likely to collide with the front cross member 32 before the timing at which the front body component collides with the case 53. This increases of the probability of reducing the load applied to the case 53, and thus decreases the probability of damaging the case 53.

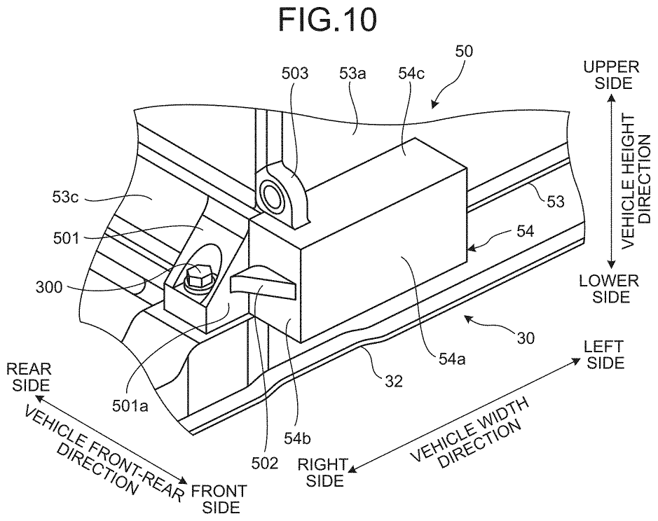

FIG. 10 is a partially enlarged view of the SPU 50 mounted on the component mounting frame 30. The SPU 50 is bolted to the component mounting frame 30. For example, as illustrated in FIG. 10, a bracket 501 provided on the right side surface 53c of the case 53 and the front cross member 32 of the component mounting frame 30 are fastened by a bolt 300.

The bracket 501 provided on the right side surface 53c of the case 53 is adjacent to the protrusion 54 provided on the front side surface 53a of the case 53. A front side surface 501a of the bracket 501 and a right side surface 54b of the protrusion 54 are connected by using a gusset 502. This enables the gusset 502 to function as a reinforcing member that reinforces the right side surface 54b of the protrusion 54, making it possible to increase the strength of the right side surface 54b of the protrusion 54 so as to suppress damage. Furthermore, the collision load input to the protrusion 54 will be input to the front cross member 32 via the gusset 502, the bracket 501 and the bolt 300. This makes it possible to reduce the collision load input to the case 53, suppressing the damage to the case 53. Furthermore, the upper surface 54c of the protrusion 54 and the front side surface 53a located above the protrusion 54 are connected by a retainer 503 retained by a chuck arm in transporting the SPU 50 or the like. With this configuration, the retainer 503 functions as a reinforcing member for reinforcing the upper surface 54c of the protrusion 54, making it possible to increase the strength of the upper surface 54c of the protrusion 54, leading to suppression of damage.

Here, the SPU 50 according to the embodiment has a configuration in which a part of the front side surface 53a on at least one of the case upper portion 53A or the case lower portion 53B protrudes toward the front side in the vehicle front-rear direction beyond the other parts of the front side surface 53a, so as to form the protrusion 54. In this configuration of the SPU 50 according to the embodiment, the low voltage component 52 is disposed behind the protrusion 54 and on the front side in the vehicle front-rear direction.

### Configuration Example 1

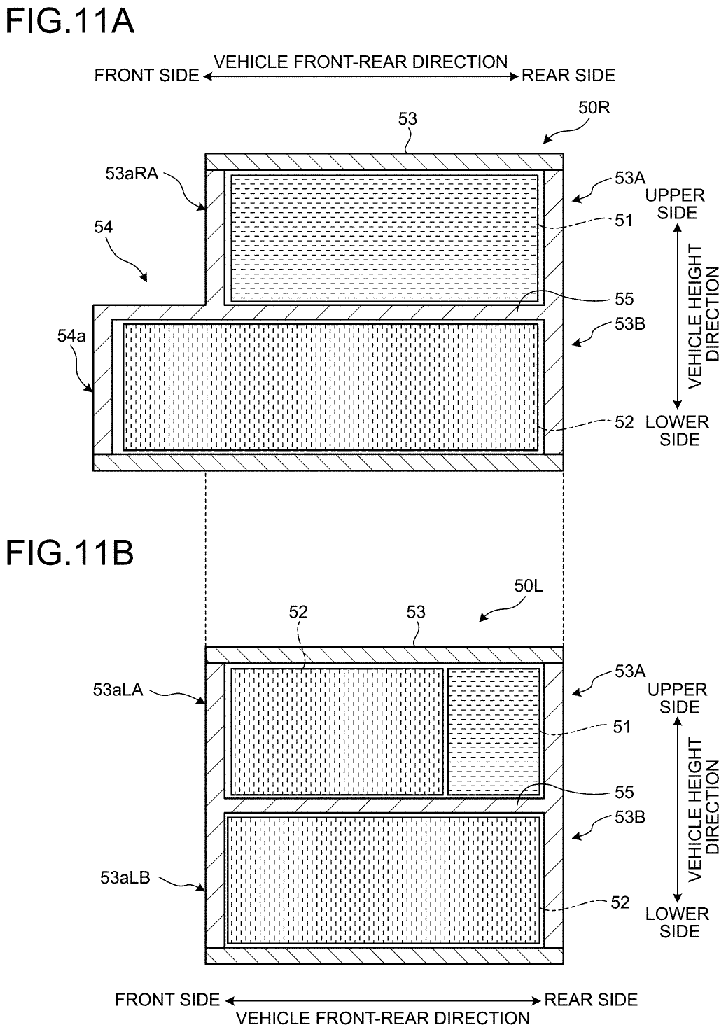

FIG. 11A is a view illustrating a right side portion in a vehicle width direction of the SPU 50 according to a configuration example 1 in the D-D cross section of FIG. 9. FIG. 11B is a view illustrating a left side portion in the vehicle width direction of the SPU 50 according to the configuration example 1 in the E-E cross section of FIG. 9. The following configuration examples including the configuration example 1 omits illustrations of the flow path forming member 56 and the flow path 57 provided in the case lower portion 53B.

Furthermore, in the following description, the right side portion of the SPU 50 in the vehicle width direction is also simply referred to as a right side portion 50R of the SPU 50. Furthermore, in the following description, the left side part of the SPU 50 in the vehicle width direction is also simply described as a left side portion 50L of the SPU 50.

Furthermore, in the following description, in the front side surface 53a of the case 53 in the right side portion 50R of the SPU 50, the surface corresponding to the case upper portion 53A is also described as an upper right front side surface 53aRA. Furthermore, in the following description, in the front side surface 53a of the case 53 in the right side portion 50R of the SPU 50, the surface corresponding to the case lower portion 53B is also described as a lower right front side surface 53aRB. Furthermore, in the following description, in the front side surface 53a of the case 53 in the left side portion 50L of the SPU 50, the surface corresponding to the case upper portion 53A is also described as an upper left front side surface 53aLA. Furthermore, in the following description, in the front side surface 53a of the case 53 in the left side portion 50L of the SPU 50, the surface corresponding to the case lower portion 53B is also described as a lower left front side surface 53aLB.

In the SPU 50 according to the configuration example 1, as illustrated in FIGS. 11A and 11B, the protrusion 54 of the case 53 is formed so as to protrude in more front side in the vehicle front-rear direction, beyond the other parts of the front side surface 53a, that is, the upper right front side surface 53aRA and the upper left front side surface 53aLA, and the lower left front side surface 53aLB.

As illustrated in FIG. 11A, the high voltage component 51 is disposed in the case upper portion 53A in the right side portion 50R of the SPU 50. Furthermore, within the case lower portion 53B of the right side portion 50R of the SPU 50, the low voltage component 52 is disposed adjacent to the protrusion 54 in the vehicle front-rear direction.

As illustrated in FIG. 118, within the case upper portion 53A in the left side portion 50L of the SPU 50, the low voltage component 52 is disposed on the front side in the vehicle front-rear direction, and the high voltage component 51 is disposed on the rear side in the vehicle front-rear direction. In addition, the low voltage component 52 is disposed in the case lower portion 53B in the left side portion 50L of the SPU 50.

In the SPU 50 according to the first configuration example, at the time of occurrence of frontal collision in the electric vehicle 1, the front side surface 54a of the protrusion 54 is likely to receive collision load before the other front side surfaces 53a, specifically, the upper right front side surface 53aRA, the upper left front side surface 53aLA, and the lower left front side surface 53aLB. In addition, as illustrated in FIG. 11A, the low voltage component 52 is disposed adjacent to the protrusion 54 while the high voltage component 51 is not disposed adjacent to the protrusion 54 in the vehicle front-rear direction. Therefore, even when the protrusion 54 is damaged, it is possible to suppress the exposure of the high voltage component 51 from the damaged protrusion 54 to the outside.

Furthermore, as illustrated in FIGS. 11A and 11B, a part of the protrusion 54 is formed by the partition wall 55 extending in more front side in the vehicle front-rear direction, beyond the other parts of the front side surface 53a (that is, the upper right front side surface 53aRA and the upper left front side surface 53aLA, and the lower left front side surface 53aLB). This can increase the compressive strength of the protrusion 54 at the time of frontal collision of the electric vehicle 1, making it possible to suppress damage to the protrusion 54.

### Configuration Example 2

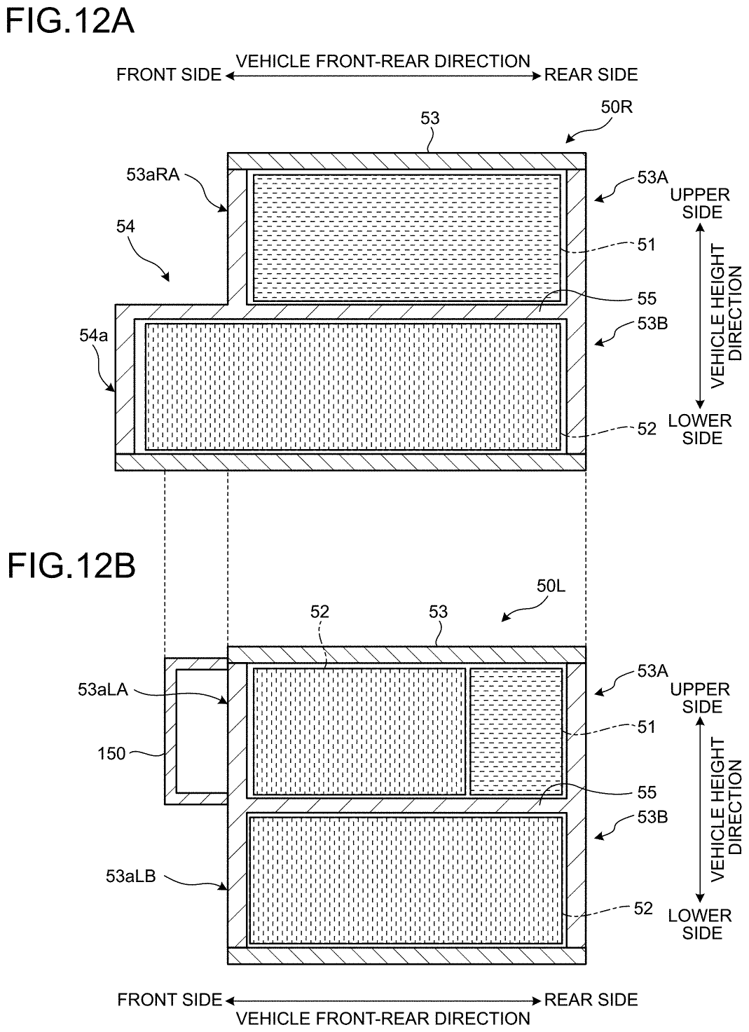

FIG. 12A is a view illustrating the right side portion 50R of the SPU 50 according to a configuration example 2 in the D-D cross section of FIG. 9. FIG. 12B is a view illustrating the left side portion 50L of the SPU 50 according to the configuration example 2 in the E-E cross section of FIG. 9.

In the SPU 50 according to the configuration example 2, as illustrated in FIGS. 12A and 12B, the protrusion 54 of the case 53 is formed so as to protrude in more front side in the vehicle front-rear direction beyond the other parts of the front side surface 53a, that is, the upper right front side surface 53aRA and the upper left front side surface 53aLA, and the lower left front side surface 53aLB.

As illustrated in FIG. 12A, the high voltage component 51 is disposed in the case upper portion 53A in the right side portion 50R of the SPU 50. Furthermore, within the case lower portion 53B of the right side portion 50R of the SPU 50, the low voltage component 52 is disposed adjacent to the protrusion 54 in the vehicle front-rear direction.

As illustrated in FIG. 12B, within the case upper portion 53A in the left side portion 50L of the SPU 50, the low voltage component 52 is disposed on the front side in the vehicle front-rear direction, while the high voltage component 51 is disposed on the rear side in the vehicle front-rear direction. In addition, the low voltage component 52 is disposed in the case lower portion 53B in the left side portion 50L of the SPU 50.

In the SPU 50 according to the configuration example 2, the high voltage component 51 is not disposed adjacent to the protrusion 54 in the vehicle front-rear direction as illustrated in FIG. 12A, similarly to the SPU 50 according to the configuration example 1. Therefore, even when the protrusion 54 is damaged at the time of frontal collision in the electric vehicle 1, it is possible to suppress the exposure of the high voltage component 51 from the damaged protrusion 54 to the outside.

Furthermore, as illustrated in FIG. 12B, the SPU 50 according to the configuration example 2 includes a terminal cover 150 formed of resin disposed on the upper left front side surface 53aLA of the case 53. The terminal cover 150 covers, for example, a connecting portion between a DC charging relay 521 side terminal which is a low voltage component 52 and electrically connected via an opening provided in the upper left front side surface 53aLA of the case 53, and a power line side terminal electrically connected to the DC charging inlet 61. It is desirable to dispose the terminal cover 150 so as not to protrude toward the front side in the vehicle front-rear direction beyond the protrusion 54 provided on the lower right front side surface 53aRB of the case 53 illustrated in FIG. 12A.

The terminal cover 150 is lower in the strength than the case 53 formed of metal. Therefore, even when the terminal cover 150 colliding with the front body component is pressurized against the case 53 when the electric vehicle 1 has a frontal collision, the case 53 would not be easily damaged. In this manner, even when the terminal cover 150 formed of resin is provided on the upper left front side surface 53aLA of the case 53, it is possible to suppress the damage to the case 53. The high voltage component 51 is disposed on the rear side in the vehicle front-rear direction within the case upper portion 53A as illustrated in FIG. 12B. Accordingly, even when the terminal cover 150 is pressurized toward the case 53 and the upper left front side surface 53aLA of the case 53 is damaged, it is possible to suppress the exposure of the high voltage component 51 to the outside.

### Configuration Example 3

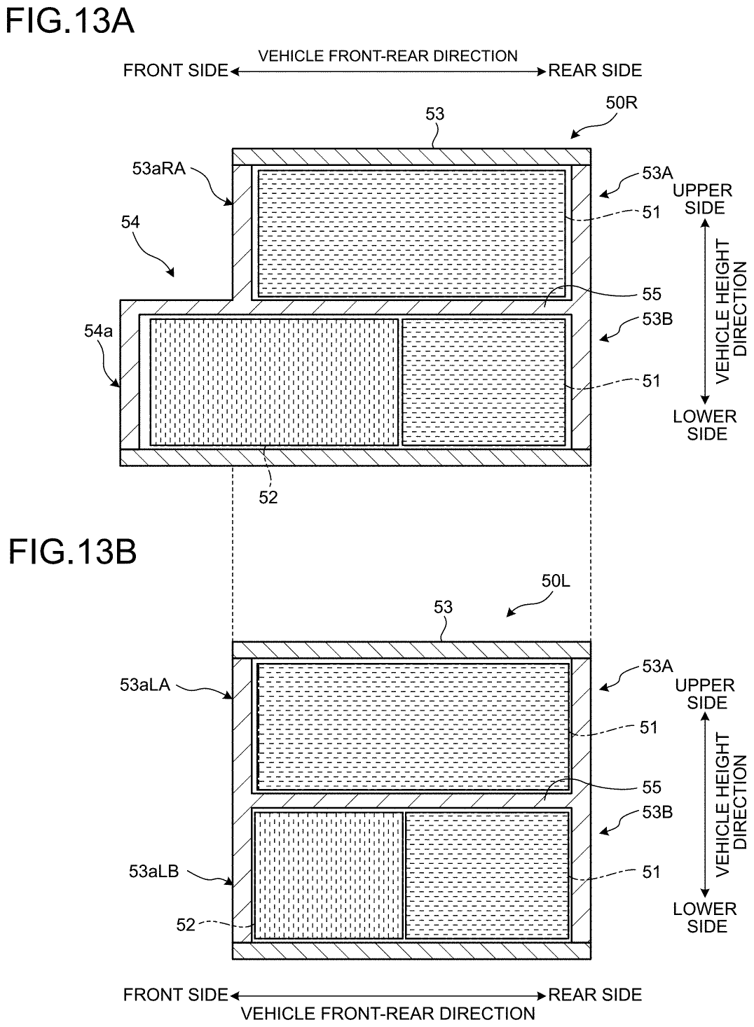

FIG. 13A is a view illustrating the right side portion 50R of the SPU 50 according to a configuration example 3. FIG. 13B is a view illustrating the left side portion 50L of the SPU 50 according to the configuration example 3. The cross sectional position of the right side portion 50R of the SPU 50 illustrated in FIG. 13A is a position corresponding to the D-D cross section of FIG. 9. The cross sectional position of the left side portion 50L of the SPU 50 illustrated in FIG. 13B is a position corresponding to the E-E cross section of FIG. 9.

In the SPU 50 according to the configuration example 3, as illustrated in FIGS. 13A and 13B, the protrusion 54 of the case 53 is formed so as to protrude in more front side in the vehicle front-rear direction, beyond the other parts of the front side surface 53a, that is, the upper right front side surface 53aRA and the upper left front side surface 53aLA, and the lower left front side surface 53aLB.

As illustrated in FIG. 13A, the high voltage component 51 is disposed in the case upper portion 53A in the right side portion 50R of the SPU 50. Furthermore, within the case lower portion 53B in the right side portion 50R of the SPU 50, the low voltage component 52 is disposed on the front side in the vehicle front-rear direction, while the high voltage component 51 is disposed on the rear side in the vehicle front-rear direction. In other words, the low voltage component 52 is disposed adjacent to the protrusion 54 in the vehicle front-rear direction in the case lower portion 53B, while the high voltage component 51 is disposed on the rear side of the low voltage component 52 in the vehicle front-rear direction.

As illustrated in FIG. 13B, the high voltage component 51 is disposed in the case upper portion 53A in the left side portion 50L of the SPU 50. Within the case lower portion 53B in the left side portion 50L of the SPU 50, the low voltage component 52 is disposed on the front side in the vehicle front-rear direction, while the high voltage component 51 is disposed on the rear side in the vehicle front-rear direction.

Similarly to the SPU 50 according to the configuration example 1, the SPU 50 according to the configuration example 3 has a configuration in which the low voltage component 52 is disposed behind the protrusion 54 in the case lower portion 53B and on a front side in the vehicle front-rear direction while the high voltage component 51 is disposed on the rear side in the vehicle front-rear direction, as illustrated in FIG. 13B. Therefore, even when the protrusion 54 is damaged when the electric vehicle 1 has a frontal collision, it is possible to suppress the exposure of the high voltage component 51 from the protrusion 54 to the outside.

As illustrated as the SPU 50 according to the configuration example 3, the high voltage component 51 can be arranged in the case 53 on the rear side in the vehicle front-rear direction even when it is behind the protrusion 54. Accordingly, it is possible to increase the degree of freedom in the layout of the high voltage component 51 within the case 53. As a result, the space inside the case 53 can be effectively used, leading to downsizing of the SPU 50.

### Configuration Example 4

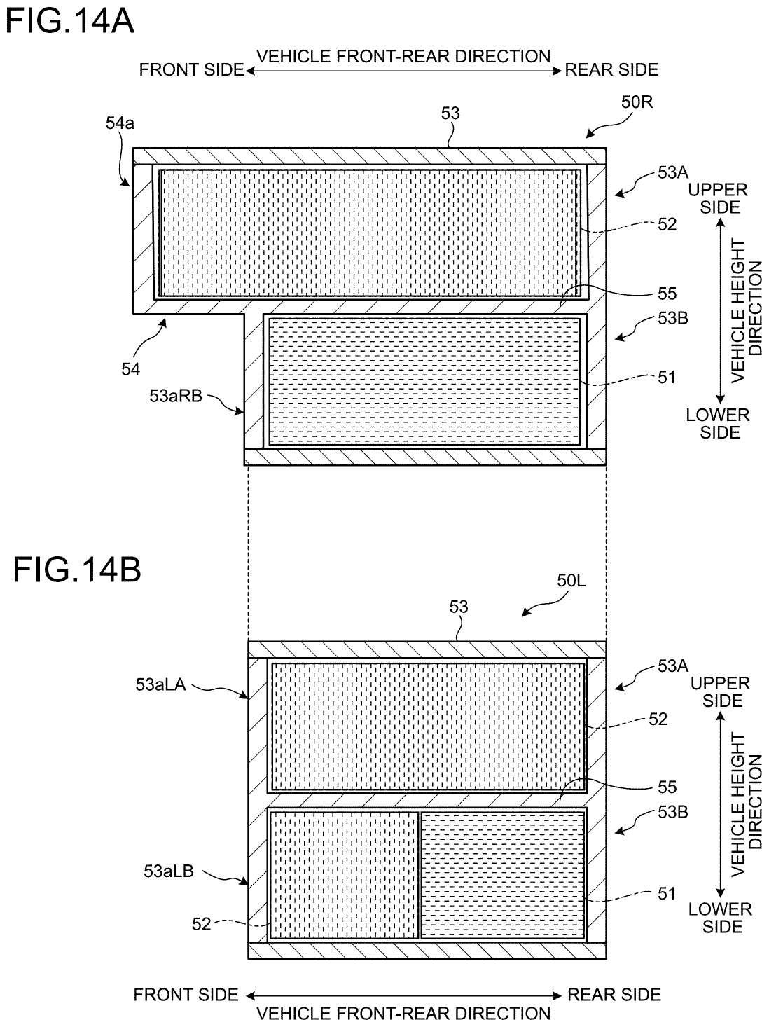

FIG. 14A is a view illustrating the right side portion 50R of the SPU 50 according to a configuration example 4. FIG. 14B is a view illustrating the left side portion 50L of the SPU 50 according to the configuration example 4. The cross sectional position of the right side portion 50R of the SPU 50 illustrated in FIG. 14A is a position corresponding to the D-D cross section of FIG. 9. The cross sectional position of the left side portion 50L of the SPU 50 illustrated in FIG. 14B is a position corresponding to the E-E cross section of FIG. 9.

In the SPU 50 according to the configuration example 4, as illustrated in FIGS. 14A and 14B, the protrusion 54 of the case 53 is formed so as to protrude in more front side in the vehicle front-rear direction beyond the other parts of the front side surface 53a, that is, the lower right front side surface 53aRB and the upper left front side surface 53aLA, and the lower left front side surface 53aLB.

As illustrated in FIG. 14A, within the case upper portion 53A of the right side portion 50R of the SPU 50, the low voltage component 52 is disposed adjacent to the protrusion 54 in the vehicle front-rear direction. In addition, the high voltage component 51 is disposed in the case lower portion 53B in the right side portion 50R of the SPU 50.

As illustrated in FIG. 14B, the low voltage component 52 is disposed in the case upper portion 53A in the left side portion 50L of the SPU 50. Within the case lower portion 53B in the left side portion 50L of the SPU 50, the low voltage component 52 is disposed on the front side in the vehicle front-rear direction, while the high voltage component 51 is disposed on the rear side in the vehicle front-rear direction.

In the SPU 50 according to the configuration example 4, at the time of occurrence of frontal collision in the electric vehicle 1, the front side surface 54a of the protrusion 54 is likely to receive collision load before the other front side surfaces 53a, specifically, the lower right front side surface 53aRB, the upper left front side surface 53aLA, and the lower left front side surface 53aLB. In addition, even when the protrusion 54 is damaged, as illustrated in FIG. 14A, the low voltage component 52 is disposed adjacent to the protrusion 54 while the high voltage component 51 is not disposed adjacent to the protrusion 54 in the vehicle front-rear direction. Therefore, it is possible to suppress the exposure of the high voltage component 51 from the damaged protrusion 54 to the outside.

In the SPUs 50 of the above configuration examples 1 to 4, the protrusion 54 is formed on the right side portion 53R of the case 53. However, the present disclosure is not limited to this. For example, in the SPU 50 according to an embodiment, the protrusion 54 may be formed on the left side portion 53L of the case 53. That is, at least a part of one of the upper left front side surface 53aLA or the lower left front side surface 53aLB of the case 53 may protrude to the front side in the vehicle front-rear direction beyond the other parts of the front side surface 53a to form the protrusion 54. Furthermore, for example, in the SPU 50 according to an embodiment, a part of the front side surface 53a may protrude to the front side in the vehicle front-rear direction beyond the other parts of the front side surface 53a over the right side portion 53R and the left side portion 53L of the case 53 so as to form the protrusion 54. In any of the examples, it is sufficient as long as the high voltage component 51 is not disposed adjacent to the protrusion 54 in the vehicle front-rear direction.

As described above, according to the electric vehicle 1 of an embodiment, when the electric vehicle 1 has a frontal collision, it is possible to suppress occurrence of damage to the case 53 and exposure of the high voltage component 51 to the outside.

In the power control unit according to the present disclosure, when an electric vehicle has a frontal collision, a protrusion provided on a part of a side surface of the housing is likely to receive a collision load before the other parts on the side surface. Furthermore, in the power control unit according to the present disclosure, class-2 component is disposed adjacent to the protrusion. Therefore, even when the protrusion is damaged, it is possible to suppress exposure of a class-1 component from the damaged protrusion to the outside. Accordingly, the power control unit of the present disclosure is capable of suppressing exposure, from a housing, of an electronic component defined as a target required to suppress exposure from the housing to the outside when a vehicle has a frontal collision.

According to an embodiment, when an electric vehicle has a collision, a protrusion provided on a part of a side surface of the housing is likely to receive a collision load before the other parts on the side surface. Furthermore, in the power control unit according to the present disclosure, class-2 component is disposed adjacent to the protrusion. Therefore, even when the protrusion is damaged, it is possible to suppress exposure of a class-1 component from the damaged protrusion to the outside.

According to an embodiment, when an electric vehicle has a frontal collision, the protrusion provided on a part of a front side surface of the housing is likely to receive a collision load before the other parts on the front side surface. Furthermore, in the power control unit according to the present disclosure, a class-2 component is disposed adjacent to the protrusion in the vehicle front-rear direction. Therefore, even when the protrusion is damaged, it is possible to suppress exposure of a class-1 component from the damaged protrusion to the outside.

According to an embodiment, it is possible to reduce the number of components and the cost as compared with the case where the protrusion is provided separately from the housing.

According to an embodiment, it is possible to increase the compressive strength of the protrusion at the time of frontal collision of the vehicle, making it possible to suppress damage to the protrusion.

According to an embodiment, it is possible to increase the degree of freedom in the layout of the class-1 components within the housing while suppressing the exposure of the class-1 components from the damaged protrusion to the outside.

According to an embodiment, when the vehicle has a frontal collision and the housing is pushed out rearward, the ribs receive the collision load before the rear side surface of the housing. This makes it possible to reduce the collision load input to the rear side surface, leading to suppression of damage to the housing.

According to an embodiment, it is possible, by using the reinforcing member, to increase the strength of the protrusion so as to suppress damage to the protrusion.

According to an embodiment, it is possible to suppress exposure of an electronic component, as a class-1 component, whose operating voltage at the time of traveling of the vehicle becomes a high voltage being a predetermined value or more, from inside the housing to the outside when the vehicle has a frontal collision.

According to an embodiment, even when the protrusion of the housing is damaged when a vehicle in traveling has a frontal collision, it is possible to use an electronic component exposed from the damaged protrusion to the outside as a charger to which no power is supplied during traveling of the vehicle.

According to an embodiment, it is possible to increase the strength of the housing to suppress damage to the housing.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power control unit mounted in a front space of a vehicle and configured to control power input to a power storage device mounted on the vehicle and power output from the power storage device, the power control unit comprising:
a housing; and
a plurality of electronic components provided in the housing;
wherein the plurality of electronic components includes a class-1 component defined as a target required to suppress exposure from the housing and a class-2 component other than the class-1 component,
a protrusion is provided on a part of a side surface of the housing so as to protrude beyond the other parts of the side surface, and
the class-2 component is disposed adjacent to the protrusion.

2. The power control unit according to claim 1,
wherein the protrusion is provided on a part of a front side surface of the housing in a vehicle front-rear direction so as to protrude toward a front side beyond the other parts of the front side surface in the vehicle front-rear direction, and
the class-2 component is disposed adjacent to the protrusion in the vehicle front-rear direction.

3. The power control unit according to claim 2,
wherein the housing internally includes a partition wall that partitions an upper portion of the housing and a lower portion of the housing, and
the protrusion is formed such that a part of the front side surface on at least one of the upper portion of the housing and the lower portion of the housing protrudes to the front side in the vehicle front-rear direction beyond the other parts of the front side surface.

4. The power control unit according to claim 3, wherein a part of the protrusion is the partition wall extending to the front side in the vehicle front-rear direction beyond the other parts of the front side surface.

5. The power control unit according to claim 2, wherein the class-1 component is located at a rear side of the class-2 component in the vehicle front-rear direction, with the class-2 component disposed adjacent to the protrusion.

6. The power control unit according to claim 1, wherein the housing includes, on a rear side surface of the housing, a rib that is erected toward a rear side in the vehicle front-rear direction.

7. The power control unit according to claim 1, wherein the housing includes a reinforcing member that reinforces the protrusion.

8. The power control unit according to claim 1, wherein the class-1 component is an electronic component having an operating voltage of a predetermined value or more when the vehicle is traveling.

9. The power control unit according to claim 1, wherein the class-2 component includes a charger that charges the power storage device by using power from an external power source provided outside the vehicle.

10. The power control unit according to claim 1, wherein the housing is formed of metal.
